(19) United States
(12) Patent Application Publication
(10) Pub. No.: US 2005/0010606 A1
(43) Pub. Date: Jan. 13, 2005

(54) Data organization for database optimization

(76) Inventors: Martin Kaiser, Speyer (DE); Volker Sauermann, Heidelberg (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/617,141

(22) Filed: Jul. 11, 2003

(51) Int. Cl. G06F 17/30

(52) U.S. Cl. 707/200

(57) ABSTRACT

Techniques for organizing and searching data are described. Specifically, data objects are stored in a table, where the data objects correspond to nodes on a directed graph. The directed graph may represent, for example, a hierarchical structure of a company's organizational model. Additionally, path information is stored in, or accessed through, the table for each object, where the path information represents every path through the directed graph of which the corresponding object is a part. In this way, queries against the table that require the path information may be answered quickly and efficiently.

### TECHNICAL FIELD

This description relates to information storage systems, such as database systems.

### BACKGROUND

In computer-based data storage systems, data is stored in and retrieved from some medium, such as a memory and a hard disk drive. The most common way to approach a database is via a database query, for example in the form of a SQL statement. Such a database query is often in a compound form (i.e., it requires at least two conditions to be fulfilled). Data can be stored in numerous formats, and a search for data that conforms to a particular query can be done in a number of ways.

In particular, data may be stored in a structure that reflects real-world relationships. For example, in a Human Resources database, a hierarchy of data may be set up which mirrors an organizational situation in which workers report to on-site managers, who in turn report to a project manager, who reports to a Board of Directors. Having a data storage system that reflects the real-world structure of, in this case, an organization may be advantageous. Nonetheless, in such systems, the branching nature of the data storage may result in difficulties when responding to a query.

For example, in order to definitively determine that a specific worker is not under the supervision of a particular project manager, a database system may be forced to individually examine each path between the project manager and the individual workers (i.e., in this case, all paths traversing the various on-site managers). Although this process is simple in theory, it may become impractical for databases storing large numbers of records and/or having a multi-leveled hierarchical structure. As a result, queries that require information about a relationship, if any, between two or more points in a hierarchical database system may require an inordinately long period of time to return an appropriate reply. Such difficulties are typically exacerbated for databases having storage systems that are more complicated than the simple hierarchical tree structure described above.

### SUMMARY

According to one general aspect, data objects are stored as nodes in a directed graph, and path information for a first object corresponding to a first node also is stored. The path information provides relational information about a direct path through the directed graph between the first node and a second node, where the second node is separated from the first node along the direct path by at least a third node.

Implementations may include one or more of the following features. For example, a query may be accepted regarding the first node, the first object may be locating, and the path information may be accessed to respond to the query.

In storing data objects, each data object may be stored in a first column of a data table, and a relation of the first data object to a consecutive data object may be stored in a second field of the data table, where the consecutive data object is connected to the first data object in the directed graph by a single edge. In this case, the path information may be stored in a third field of the data table.

In storing path information, a data string may be stored as the path information, where the data string includes at least the second node and the third node. In this case, the data string may be compared to a query regarding the first node, in order to respond to the query. Also, in storing the data string, a first direct path through the directed graph of which the first node is a part may be determined, a first data string may be determined based on the first direct path, a second direct path through the directed graph of which the first node is a part may be determined, a second data string may be determined based on the second direct path, and the first data string and the second data string may be concatenated for storing as the path information.

In storing path information, the relational information may be transformed into a coded value. Also, the path information may be updated to reflect changes in the directed graph. The directed graph may include a hierarchical, multi-leveled data structure.

According to another general aspect, an apparatus comprises a storage medium having instructions stored thereon. The instructions include a first code segment for storing data objects within a table, a second code segment for storing a relation of a first data object to a second data object in the table, where the first data object and the second data object correspond to consecutive nodes on a directed graph, and a third code segment for storing path information associated with the first data object in the table, where the path information describes a path within the directed graph that is between the first node, the second node, and a third node.

Implementations may include one or more of the following features. For example, the apparatus may include a fourth code segment for accepting a query about the first node and a possible relation of the first node to another node within the directed graph, and a fifth code segment for responding to the query based on the path information. In this case, the fifth code segment may include a sixth code segment for detecting the first data object within the table and comparing the path information to the query.

The first data object, the second data object, and the path information may be stored in separate columns of a single row of the table. The third code segment may store the path information as a data string listing the second node and the third node. Alternatively, the third code segment may store the path information as a coded value generated from information about the second and third node and their locations within the directed graph.

According to another general aspect, a system may include means for accessing path information that describes a path through a directed graph between a first node and a plurality of other nodes, and means for responding to a query involving the first node, based on the path information.

Implementations may include one or more of the following features. For example, the means for accessing path information may include means for storing the path information or a reference to the path information in a table containing a first data object corresponding to the first node.

The means for responding to the query may include means for directly locating the first data object within the table in response to the query, or may include means for performing a pattern match between the query and a data string listing the path through the directed graph.

The details of one or more implementations are set forth in the accompanying drawings and the description below. Other features will be apparent from the description and drawings, and from the claims.

### DESCRIPTION OF DRAWINGS

FIG. 1 is a block diagram of a data storage and access system.

FIG. 2 is a diagram of a directed graph for storing hierarchical information.

FIG. 3 illustrates a specific path through the directed graph of FIG. 2.

FIG. 4 is a flowchart illustrating a search technique for searching a database of FIG. 1.

### DETAILED DESCRIPTION

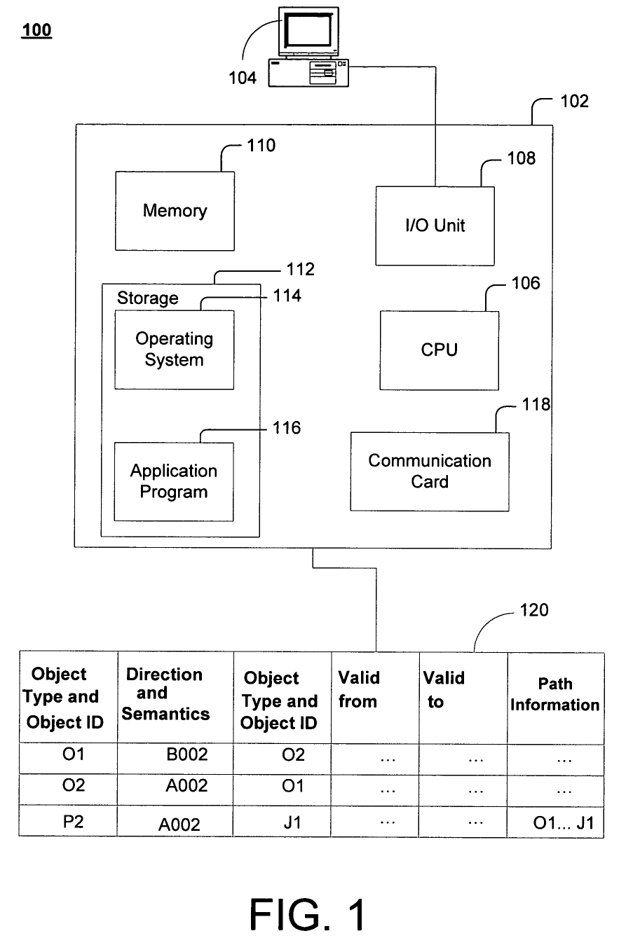

FIG. 1 is a block diagram of a data storage and access system 100. In FIG. 1, a system 102, generally referred to herein as a “database system” or “database,” is accessed by a computer 104 used to submit queries to the database 102. The computer 104 may access the database 102 directly, or may communicate with the database 102 using a computer network such as the public Internet or a local intranet. Although only one computer 104 is illustrated in FIG. 1, it should be understood that various types of computers may be used to access the database 102. Also, multiple computers may be used to access the database system 102 simultaneously.

The database 102 should be understood to have (or have access to) any conventional components needed to store, access, and modify data. By way of illustration, the database 102 in FIG. 1 is illustrated as having a central processor unit (CPU) 106, an I/O unit 108 for communicating with the computer 104, memory 110, and a storage device 112. Storage device 112 may store machine-executable instructions, data, and various programs, such as an operating system 114 and one or more application programs 116, all of which may be processed by CPU 106. A communications card 118 may be used to communicate with a computer network, as referred to above.

Each computer application program 116 may be implemented in a high-level procedural or object-oriented programming language, or in assembly or machine language if desired. The language may be a compiled or interpreted language. Data storage device 112 may be any form of non-volatile memory, including, for example, semiconductor memory devices, such as Erasable Programable Read-Only Memory (EPROM), Electrically Erasable Programable Read-Only Memory (EEPROM), and flash memory devices; magnetic disks such as internal hard disks and removable disks; magneto-optical disks; and Compact Disc Read-Only Memory (CD-ROM).

Any of the elements of the database 102, and other elements not specifically illustrated that may be used in, or in conjunction with, the database 102, may be supplemented by, or incorporated in, application-specific integrated circuits (ASICs). Memory may be any form of memory, including, for example, main random access memory (RAM).

Data may be stored in the database 102 in any machine-based format, such as, for example, a database, a flat file, a spreadsheet, a file system, or any combination thereof. Information stored in the database 102 may be, in whole or in part, freeform, such as a text files, web pages, or articles, or it may be structured such as data records or Extensible Markup Language (XML) files.

Relational database management systems (RDBMS), such as Oracle, Sybase, DB2, SQL Server, and Informix, provide a mechanism for storing, searching, and retrieving structured data. For example, an RDBMS storing a customer list may facilitate searching and receiving customer records by attributes such as name, company, or address. In RDBMS systems, data records are typically organized in tables. Each table includes one or more data records, and each data record includes data fields for storing information associated with one or more attributes.

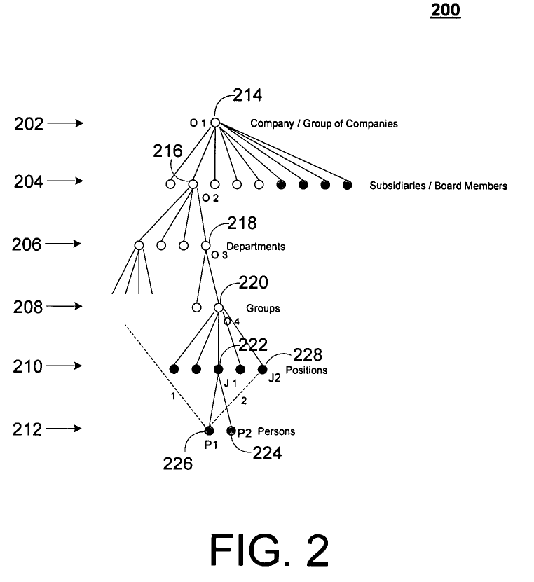

In FIG. 1, the database system 102 is used to store a table 120, which stores information in a hierarchical manner. More specifically, FIG. 2 is a block diagram of a directed graph 200 for storing hierarchical information, and the table 120 corresponds to the directed graph 200. In FIG. 2, business objects are represented as nodes on the directed graph 200.

In FIG. 2 and in the following discussion, the term “object” or “data object,” should be understood to mean any discrete concept that may be represented for storage in the database 102. For example, an object might represent a person or group of persons, a location, an event, a qualification or other ratings level, a form or contract, or any other component, entity, or constituent that may be considered to be associated with an operation of a given model or process. In a business environment, an object may be referred to specifically as a “business object,” and, further, it should be understood that comparable terminology could be used to refer to objects in other environments, as may be needed or desired by a user.

In FIG. 2, a first or top level 202 corresponds to a company (or group of companies), a second level 204 corresponds to subsidiaries and/or board members of the company, and a third level 206 corresponds to departments of the subsidiaries. A fourth level 208 corresponds to groups within the specific departments, while a fifth level 210 corresponds to positions within the departments, and, finally, a sixth level 212 corresponds to persons occupying the various positions.

The graph 200 of FIG. 2 is primarily intended for use in the Human Capital Management (HCM) field, and/or the Human Resources (HR) field. However, it should be understood that similar hierarchies, which may be represented by similar graphs, occur in many different circumstances. For example, such graphs may be used in event management (e.g., allowing a facility to maximize/prioritize resource usage), a training hierarchy (e.g., for new and/or promoted employees), or in skills development (e.g., where company employees are put in a qualification hierarchy).

As seen in FIG. 2, each of the levels 202-212 includes a data object or node that branches to one or more objects/nodes. For example, an object “O1” 214 at the company level 202 branches to many subsidiaries/board members at level 204, including an object “O2” 216. Similarly, the object O2 216 branches to various departments at level 206, including a department object “O3” 218. In turn, the department object O3 218 branches to groups at the level 208 that include a group object “O4” 220, which branches to positions including a position object “J1” 222 at the level 210. Finally, the position object J1 222 branches to persons at level 212, including a person object “P2” 224.

The graph 200 of FIG. 2 is primarily illustrated as a tree structure, in which a given node has one predecessor and one or more successors. However, FIG. 2 also illustrates the possibility that a node is connected to another node that is back up the general tree structure. For example, a person object “P1” 226 may be connected to a position object “J2” 228 and to another position object, and/or to a group or department object.

Such connections reflect the fact that various relationships may exist that are additions or alternatives to the general branching tree structure. For example, a person represented by the person object or node “P1” 226 may be part of a project in another group of another department (1), or may occupy two or more positions in the same group or department on a part-time basis (2). Similarly, a given position may be occupied by several persons on a part-time basis (for example, two part-time secretaries may share one position). In such cases, positions in the hierarchy may be used, for example, as a management matrix for planning substitutes or part-time work.

In short, the graph 200 does not represent simply a hierarchical tree structure, but rather represents multi-directional hierarchies as directed graphs, in which connections (also referred to as edges) between nodes are ordered pairs of nodes (also referred to as vertices). That is, each edge can be followed from one node to the next. Directed graphs are also known as digraphs or oriented graphs.

For the purposes of this description, a path or direct path through a hierarchically-structured directed graph such as the graph 200 of FIG. 2 generally refers to a sequence of nodes following in the direction (or in the reverse direction) of a plurality of edges. Thus, in the graph 200 of FIG. 2, a direct path may follow from the company level 202, to the subsidiary/Board of Directors level 204, to the departments level 206. Or, a direct path may follow from the position level 210 to the person level 212, and then back to the group level 208. However, a direct path in the case of FIG. 2 would not generally travel from the person level 212 to the position level 210, and then back to the person level 212. Of course, if a directed graph is not structured in such a strict hierarchical form, then a path may refer to any sequence of nodes, including cyclic paths or other paths that may include the same node more than once.

In the directed graph 200 of FIG. 2, then, free networks of n:m relationships between objects occur. Any n:m relationships may be established, up or down the tree. Additionally, rules may be imposed, such as that “person” objects are (only) related to “position” objects and “position” objects are (only) related to “organization” objects.

The information of the graph 200, mentioned above, may be stored in the table 120 within the database 102. Specifically, as shown in FIG. 1, the table 120 stores each object type and/or object identification parameter (ID) in a first column. For example, the company object “O1” 214 is stored in the first column of the table 120, as well as the subsidiary object “O2” 216 and the person object “P2” 224. Although just the three objects 214, 216, and 224 are shown in the table 120, of course all of the objects of the directed graph 200 would typically be stored in the table 120.

In a second column, the table 120 holds direction and relation information between corresponding objects from the first column and a third column, along a given row. Specifically, the second column holds either an indication code “B,” indicating superordination between an object of the first column and an object of the third column, or “A,” indicating subordination between an object of the first column and an object of the third column. Further, the second column holds a code indicating a type of relationship between objects. For example, a code “002” may indicate “reporting,” whereas a code 003 may indicate “belongs to,” a code “008” indicates ownership, and a code “012” indicates a cost center assignment.

For example, in the first row, the information of the table 120 should be read as “the object ‘O1’ 214 is superordinated for reporting purposes to the object ‘O2’ 216.” Conversely, of course, the second column provides an indication that “the object ‘O2’ 216 is subordinated for reporting purposes to the object ‘O1’ 214.” As a final example, the third row provides an indication that “the object ‘P2’ 224 is subordinated for reporting purposes to the object ‘J1’ 222.”

The table 120 may include additional information that may not be explicitly shown in the example of FIG. 1. Specifically, time parameters related to the data may be stored as beginning and end dates in columns labeled “valid from” and “valid to.” For example, a person represented by the person object “P2” 224 may only be assigned to a position represented by the position object “J2” 222 for a finite period of time. Other parameters and information, not explicitly shown, also may be included in the table 120.

The table 120 further includes a column for storing path information about each object. That is, the path information column stores a complete path or paths of which the corresponding object is a part. In this way, as discussed in more detail below, path information about a given object is available for searching purposes. In other words, the path information provides information about the relevant object and its relationship(s) to any and all other objects to which it is related, which, in turn, allows for ease of searching for information about such relationships.

Thus, in the example of the table 120 of FIG. 1, the hierarchy/graph information for the directed graph 200 is folded into and stored with the actual data. This methodology may result from, for example, legacy systems that were originally designed in this way. However, without the path information stored in the path information column of the table 120, and as discussed in more detail below, this methodology may lead to time delays and inefficiencies when performing certain queries on the database 102.

For example, a common query that may be put to the database 102 involves determining whether a specific person, such as a person represented by the person object “P2” 224, is part of a specific organization. In other words, such a query may seek to determine information about an object or node that is lower on the directed graph 200 of FIG. 2 than, and usually part of many branches from, an object or node that is higher on the graph 200.

In the example of finding a specific person's relationship, if any, to a given organization, such a query may be useful for determining an authorization level of the person, e.g., to determine whether the person is authorized to display or change certain data. However, even when a unique identification parameter or number for the given person is known beforehand, it may be inefficient and time-consuming to determine the person's relationship to a specific organization.

For example, without the path information stored in the table 120, and since the hierarchy structure is part of the data, as described above, searching for a relationship (if any) between objects would require iteratively reconstituting the hierarchy one level at a time. In other words, it would not generally be possible to find out directly which organization a given person belongs to. Rather, it would be necessary to select all objects that are below the top node of the hierarchy, and then follow the hierarchy down to the level in question.

For example, selecting all objects below a given (top) object may result in N records. For each of these N records, the respective successor would be selected from the appropriate database table. This operation would result in, in this case, N select statements with M result records for each select. For these M objects, the respective successors need to be found, and so on, until the required person has been found (or not found). Thus, the number of select statements is the product of the number of hits at each level, and could easily reach several hundred or thousand select statements on the database 102.

A separate technique might involve reversing the direction of navigation, so that searches are performed by finding the requested object in the graph and following the hierarchy upward to the top node. This technique may sometimes lead to improved performance relative to the technique described above. However, since n:m relationships occur both upward and downward in the hierarchy, the improvement may be minimal, or, in some cases, non-existent.

In existing systems using the above-described techniques, for example, database tables with 100,000 objects have best-case response times of approximately 30-40 seconds. Such systems require specific hardware and a well-tuned system and database to provide even this result. Of course, results are worse when, as occurs in many typical user scenarios, millions of objects at dozens of levels exist.

In the data storage and access system 100 of FIG. 1, however, as explained above, the table 120 includes a column for storing path information related to each object. The path information, generally speaking, represents a direct path through the graph 200 from a top node down to (or through) a particular object (node). For example, the path information represented for the person object “P2” 224 in the table 120 includes the object string O1 (214), O2 (216), O3 (218), O4 (220), and J1 (222). In another implementation, the path information for the person object “P2” 224 may include the person object “P2” 224 itself, although this information may be considered to be redundant, particularly for objects corresponding to nodes at a bottom of a hierarchical structure.

Of course, path information for an object corresponding to a node in a middle of a hierarchical structure or other directed graph (such as, for example, the group object “O4” 220) may include all nodes that are above and below the particular object. This path information may be stored as a single string that includes the particular object, or as two or more strings that are concatenated together within the path information column of the table 120.

Similarly, although the implementations discussed above generally describe a single path stored for each object, it should be understood that each object may be part of multiple paths. For example, a single person may work in multiple positions within an organization. In such cases, all of the multiple paths may be included in the path information column of the table 120. For example, as referred to above, multiple path strings may be concatenated, and subsequently stored in the path information column with a delimiter (e.g., a semi-colon or comma) between separate path strings.

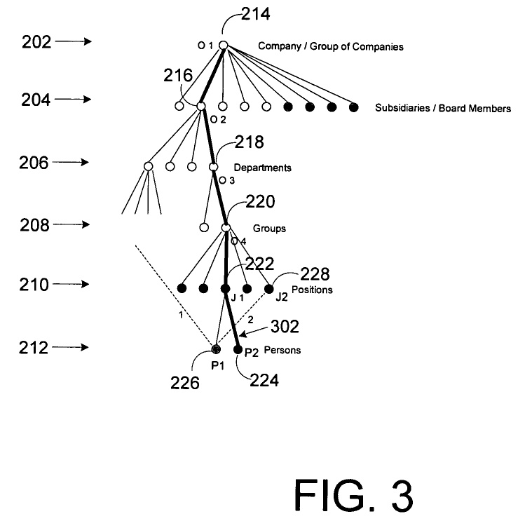

This path is illustrated in FIG. 3, which illustrates a specific path 302 through the directed graph 200 of FIG. 2. The path 302 is indicated in FIG. 3 as a bolded line, and, as shown, traverses the various objects (nodes) listed above and referred to in the path information column of the table 120 of FIG. 1.

In one implementation, as referred to above, the path information is a simple string that contains object types and object IDs for the direct path 302 from the top node 214 to the requested object 224. The appropriate application(s) associated with the database 102 may thus select the record of a requested object from the table 120 and find the corresponding path string stored in the path information column.

As a result, a query such as “does the requested object (e.g., the person object “P2” 224) belong to a specific position (e.g., the position represented by the position object “J1” 222)?” may be resolved by a pattern match between the query and the returned path string that corresponds to the requested object. Moreover, even a compound query such as “does the requested object belong to a specified department and a specified position?” also may be resolved with a relatively simple pattern matching operation performed between the objects in the query and the objects in the stored path string.

Various techniques exist for performing the pattern match referred to above. For example, in the Advanced Business Application Programming (ABAP) language, a “contains pattern” (CP) operator may be used to perform pattern matching between a query and a returned path string. In this case, the query may be answerable using a single select statement on the database 102.

Various other programming languages may include techniques for performing a similar pattern match, i.e., identifying a substring within a string. For example, the Java programming language may store the path information string as a Java object that may be matched against a query using the appropriate Java command and syntax.

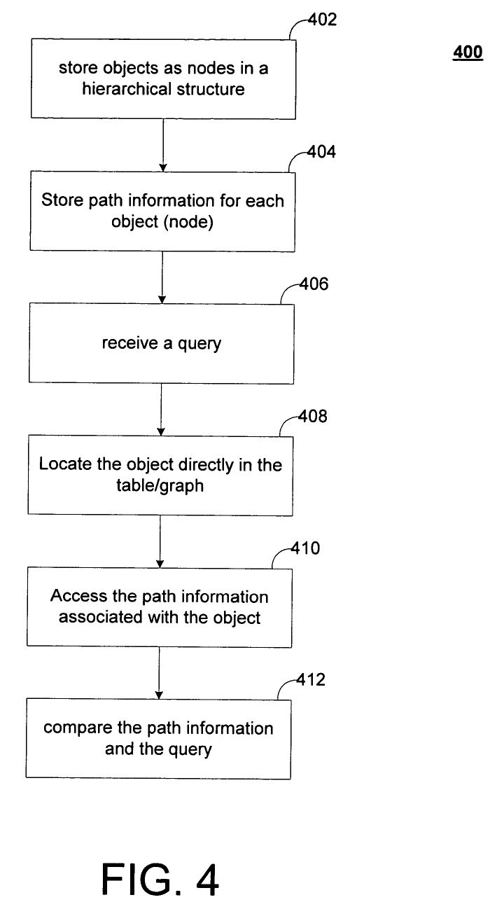

FIG. 4 is a flowchart 400 illustrating a search technique for searching the database 102 of FIG. 1, in accordance with the various implementations discussed above. In FIG. 4, objects are stored within the database 102 as nodes of a hierarchical structure (402), such as in the directed graph 200 of FIG. 2. Specifically, the data and structure of the hierarchical structure are folded into a single table, as described above, for example, with respect to the table 120.

Subsequently, or simultaneously, path information for each object is stored within the database 102 and the table 120 (404). Specifically, the path information may be stored for each object within a separate column of the table 120, as a string that includes all of the objects directly connected to the relevant object.

At some later point in time, the database 102 may receive a query from the computer 104 (406). As discussed above, such a query often may seek information about how a specific object (or objects) within the data relates (if at all) to another object (or objects) within the data.

The query is satisfied by first directly locating the object contained in the query within the graph 200 (i.e., within the table 120) (408). Then, once the object is located, the path information associated with the object is accessed (410) and compared to the query (412). In this way, queries that involve relational information between objects (nodes) in a directed graph that may be a hierarchical structure may be answered with a minimal number of select statements and in a greatly minimized amount of time compared to conventional systems.

Over time, of course, the path information in the table 120 may change. For example, a person may be reassigned to a new position, or an organizational structure of a company may be altered. Thus, although not illustrated in FIG. 4, it should be understood that the path information may be recalculated on a periodic basis, for example, daily or weekly, as deemed necessary to accommodate any updates, inserts, and deletes made during the intervening time period. Since the path information is stored in a column included in an otherwise-conventional table, such updates may be conveniently and efficiently performed, even if frequent updates are required.

In the implementations discussed above, the path information is directly stored within the table 120 as a string. However, there are numerous other techniques for storing and accessing the path information. For example, the information contained within the “path information” column of the table 120 may include pointers to the various objects within a path, e.g., pointer to address(es) of the objects as they are stored in a main memory associated with the database 102.

In another implementation, the path information may be stored, accessed, and compared using a numerical representation of the path information, such as a hash value. For example, such a hash value may be obtained by using a pre-determined hash algorithm for combining numerical identifications of the objects within the path, perhaps modified by a level of the object(s) within the hierarchical structure. Then, to compare the path information and query, standard bit operations may be performed so as to search the hash value and obtain either a “null” value (indicating no match for the request) or a “not null” value (indicating a match).

In other implementations, path information may be stored using an array, in which all elements (i.e., objects) are grouped as one block of memory, or using a linked list, in which space is separately allocated for each element in its own block of memory and pointers are used to link the elements. In the latter implementation, the linked list may be transformed into a coded string/value in which all of the path information may be found.

In short, path information for an object may be stored in the database 102 in any desired manner that provides detail about the relationships of that object to other objects in a directed graph such as the graph 200 of FIG. 2. The path information may be stored, directly or indirectly, in the path information column of the table 120, such that the path information may be easily stored, accessed or modified when used in conjunction with existing database systems.

Also, although the above description primarily deals with a hierarchical structure stored as a directed graph, it should be understood that any data that may be stored by representing objects as nodes in a directed graph may be more easily searched by using the techniques described herein.

Finally, although the above implementations have been described with respect to the database system 102 of FIG. 1, which is intended to represent many types of database systems, it should be understood that even other systems arguably not represented by the database system 102 that are used for storing and accessing information may benefit from the techniques described herein. For example, technologies exist for replicating and caching data from systems such as the database system 102, so as to improve access time for accessing the data stored therein. In such cases, the data may be cached using an organization similar to that described above, or may use some other organizational and/or access techniques for improving a speed of access. In any such case, the storage and use of path information as described herein may be advantageous when searching or otherwise accessing the cached information.

As described above, a query response time for data stored in a directed graph may be improved by storing path information for each piece of data, in conjunction with that piece of data. In this way, information about a graph/hierarchical structure of data is separated from the data, and is explicitly visible in an appropriate and searchable form. As a result, every element knows information about its relation, if any, to all other elements it is connected to, so that queries about relationships between the elements may be performed quickly and easily.

A number of implementations have been described. Nevertheless, it will be understood that various modifications may be made. Accordingly, other implementations are within the scope of the following claims.

1. A method comprising:
storing data objects as nodes in a directed graph; and
storing path information for a first object corresponding to a first node, where the path information provides relational information about a direct path through the directed graph between the first node and a second node, where the second node is separated from the first node along the direct path by at least a third node.

2. The method of claim 1 further comprising:
accepting a query regarding the first node;
locating the first object; and
accessing the path information to respond to the query.

3. The method of claim 1 wherein storing data objects comprises:
storing each data object in a first column of a data table; and
storing a relation of the first data object to a consecutive data object in a second field of the data table, where the consecutive data object is connected to the first data object in the directed graph by a single edge.

4. The method of claim 3 wherein storing path information comprises storing the path information in a third field of the data table.

5. The method of claim 1 wherein storing path information comprises storing a data string as the path information, where the data string includes at least the second node and the third node.

6. The method of claim 5 comprising comparing the data string to a query regarding the first node, in order to respond to the query.

7. The method of claim 5 wherein storing the data string comprises:
determining a first direct path through the directed graph of which the first node is a part;
determining a first data string based on the first direct path;
determining a second direct path through the directed graph of which the first node is a part;
determining a second data string based on the second direct path; and
concatenating the first data string and the second data string for storing as the path information.

8. The method of claim 1 wherein storing path information comprises transforming the relational information into a coded value.

9. The method of claim 1 wherein the directed graph includes a hierarchical, multi-leveled data structure.

10. The method of claim 1 wherein storing path information comprises updating the path information to reflect changes in the directed graph.

11. An apparatus comprising a storage medium having instructions stored thereon, the instructions including:
a first code segment for storing data objects within a table;
a second code segment for storing a relation of a first data object to a second data object in the table, where the first data object and the second data object correspond to consecutive nodes on a directed graph; and
a third code segment for storing path information associated with the first data object in the table, where the path information describes a path within the directed graph that is between the first node, the second node, and a third node.

12. The apparatus of claim 11 further comprising:
a fourth code segment for accepting a query about the first node and a possible relation of the first node to another node within the directed graph; and
a fifth code segment for responding to the query based on the path information.

13. The apparatus of claim 12 wherein the fifth code segment includes a sixth code segment for detecting the first data object within the table and comparing the path information to the query.

14. The apparatus of claim 11 wherein the first data object, the second data object, and the path information are stored in separate columns of a single row of the table.

15. The apparatus of claim 11 wherein the third code segment stores the path information as a data string listing the second node and the third node.

16. The apparatus of claim 11 wherein the third code segment stores the path information as a coded value generated from information about the second and third node and their locations within the directed graph.

17. A system comprising:
means for accessing path information that describes a path through a directed graph between a first node and a plurality of other nodes; and
means for responding to a query involving the first node, based on the path information.

18. The system of claim 17 wherein the means for accessing path information comprises means for storing the path information or a reference to the path information in a table containing a first data object corresponding to the first node.

19. The system of claim 17 wherein the means for responding to the query comprises means for directly locating the first data object within the table in response to the query.

20. The system of claim 19 wherein the means for responding to the query comprises means for performing a pattern match between the query and a data string listing the path through the directed graph.
